(19) United States
(12) Patent Application Publication
(10) Pub. No.: US 2025/0289034 A1
(43) Pub. Date: Sep. 18, 2025

(54) PROCESSING OF TRONA ORES USING SENSOR-BASED ORE SORTING SYSTEMS FOR REFINED TRONA PRODUCTS

(71) Applicant: TATA Chemicals North America Inc., Sandy, UT (US)

(72) Inventors: Eric S. Fagley, Rock Springs, WY (US); Timothy S. McCoy, South Jordan, UT (US)

(73) Assignee: TATA Chemicals North America Inc., Sandy, UT (US)

(21) Appl. No.: 18/605,519

(22) Filed: Mar. 14, 2024

(51) Int. Cl. B07C 5/342; B07C 5/02; B07C 5/34; B07C 5/36

(52) U.S. Cl. CPC B07C 5/3425; B07C 5/02; B07C 5/3416; B07C 5/366

(57) ABSTRACT

An ore-sorting system includes a trona ore screen system, the trona ore screen system including an ore crusher and a filter. The screen system is configured to produce an ore feed comprising ore particles having a predetermined size. The ore sorting system further includes a beneficiation system that receives the ore particles having a predetermined size, the beneficiation system configured to increase an economic value of the trona ore by removing gangue material, resulting in a high-grade ore product. The beneficiation system includes a laser scanner. The ore sorting system also includes a sorter configured to separate the high-grade ore product from the gangue material. The sorter includes an identification system configured to accept or reject ore. The accepted ore is deposited in a bin and rejected ore is ejected with a high-pressure air jet.

### BACKGROUND

Trona is a soft sodium carbonate mineral that can range from colorless, gray-white to light yellow. Its chemical formula is Na₃H(CO₃)₂*2H₂O. Trona is mined and processed to be converted to soda ash, which is used to make a variety of products including glass, baking soda, laundry detergent, paper, textiles, and also aids in the process of supplying potable water and clean air. The finished desired product is known as soda ash (Na₂CO₃). The products produced from soda ash can either be dense, intermediate, or light soda ash. The chemical composition of each grade of soda ash stays the same, while the density of the product may differ.

The Green River Basin in Wyoming hosts the world's largest trona deposit, supplying approximately 90% of soda ash in the United States of America. The beds of trona were deposited during the Eocene Geological Epoch in an ancient freshwater lake known as Lake Gosiute. The mineral trona is an evaporite mineral that formed in shallow waters that evaporated rapidly and continuously over millions of years. These waters would have needed to have an input of elevated levels of Na⁺ and HCO³⁻ ions. These constituents of trona were produced by the leaching of extensive pyroxene-andesite volcanic ash layers combined with a seasonal influx of carbonate-rich sediments from stream waters entering the depositional basin. Other processes that produced carbonate and bicarbonate include bacterial reduction of sulfate and the precipitation of calcium carbonate by algae. The precipitation of trona required the presence of an abundance of carbon dioxide, which was likely generated by the biogenic decay of plant and aquatic sources. Subterranean thermal springs had also played a large part in dissolving alkaline carbonates, sodium, calcium, silica, and bicarbonate ions. For a period of 4 million years, the lake underwent several cycles of filling and evaporating leaving behind beds of trona interbedded with marlstone, limestone, oil shale, and sandstone-mudstone. During periods which saw higher water levels, algae along with clastic sediments and authigenic minerals, formed organic marlstones and beds of low to high-grade oil shale.

Dense soda ash has a bulk density of 60-66 lb/ft³. This grade of soda ash is produced by hydrating light soda ash and then dehydrating using calcination to form denser crystals. It is preferred over light soda ash for the glass manufacturing industry because the light variety leads to frothing in glass melt. Light soda ash has a bulk density of 32-39 lb/ft³. It forms from calcining the sodium sesquicarbonate precipitate that is recovered from the carbonation towers or vacuum crystallizers. Light soda ash is preferred by chemical and detergent manufactures because of its ability to dissolve readily. The light-intermediate product has a bulk density of 50 lb/ft³. This grade of soda ash is used in some detergents, as well as bath salts.

### SUMMARY

Embodiments disclosed herein include assemblies, systems, and methods for the processing of trona ores using sensor-based sorting systems in order to create a range of market saleable refined trona products. In an example, an ore-sorting system can include a trona ore screen system having an ore crusher and a filter. In some examples, the screen system can be configured to produce an ore feed that includes ore particles having a predetermined size. The ore-sorting system can further include a beneficiation system that receives the ore particles having a predetermined size. The beneficiation system can be configured to increase an economic value of the trona ore by removing gangue material, resulting in a high-grade ore product. In some examples, the beneficiation system can include a laser scanner. The sore-sorting system can also include a sorter configured to separate the ultra high-grade ore product from the high-grade material. The sorter can include an identification system configured to accept or reject ore. In an example, accepted ore is deposited in a bin and rejected ore is ejected with a high-pressure air jet.

In some examples, the trona ore can include trona interbedded with at least one of a marlstone, limestone, oil shale, sandstone, or mudstone. In an example, the ore crusher pulverizes a raw ore into an ore particle having a diameter between about ⅛ inch and about 4 inches. In some examples, the laser scanner identifies trona ore having a trona concentration greater than 95%.

In an example, the beneficiation system further includes a dry separation having at least one of density, magnetic, electrostatic, optical, X-ray, or infrared separation. In some examples, the trona ore screen system can include a first trona ore feed including a large ore particle diameter and a second ore feed including a small ore particle diameter. In an example, the first ore feed can be fed to a first beneficiation system and the second ore feed can be fed to a second beneficiation system.

In some examples, the first trona ore feed and second trona ore feed can be in series. In other examples, the first trona ore feed and second trona ore feed can be in parallel.

In at least one example, an ore-sorting system can include an ore feed intake configured to receive trona ore particles and a conveyer belt. In an example, the conveyer belt can receive the trona ore particles from the ore feed intake and carries the trona ore particles to be evaluated. In an example, the trona ore particles can be configured as a monolayer on the conveyer belt. In an example, the ore-sorting system can also include a sensor configured to examine the trona ore particles on the conveyor belt to evaluate the concentration of trona in the trona ore particles and identify a high-grade ore product. The laser scanner identifies and enables the production of an ultra-high grade trona. In other words, the sensor can include a laser scanner and an ore separator that divides the high-grade ore product from high-grade mill feed trona based on the results of the sensor. In some examples, the laser scanner can transmit beams of coherent light that analyzes the trona ore particles for absorption, fluorescence and reflectance characteristics.

In some examples, the ore separator can include an identification system configured to accept or reject each trona ore particle. In an example, an accepted trona ore particle can be deposited in a bin and a rejected trona ore particle can be ejected with a high-pressure air jet. In some examples, the sensor can further include an XRT source configured to analyze the trona ore particles for their X-ray signal attenuations and determine atomic density of the trona ore particles.

In at least one example, a method for the purification of trona can include screening trona ore from an ore deposit to produce a trona ore feed comprising trona ore particles having a predetermined size. The method can also include placing the trona ore feed on a conveyer belt that receives the ore particles having a predetermined size and identifying an impurity content of the ore particles by a laser scanner. The method can further include separating the ore particles using air-jet diverters based on a purity threshold to increase an economic value of the trona ore by removing gangue material, resulting in a high-grade ore product, wherein an accepted ore particle is deposited in a bin and a rejected ore is ejected with a high-pressure air jet. In some examples, the laser scanner transmits coherent light beams of various colors to analyze the trona ore particles for absorption, reflectance and fluorescence characteristics. In some examples, the trona ore particles include a diameter between about ⅛ inch and about 4 inches.

In some examples, the purity threshold can include about 95% trona. In some examples, the method for the purification of trona can further include crushing the trona ore prior to screening trona ore. In an example, the ore feed can include a first ore feed having a large ore particle diameter and a second ore feed having a small ore particle diameter. In an example, the first ore feed can be fed to a laser scanner and the second ore feed can be fed to a second laser scanner. In an example, the first laser scanner and the second laser scanner are in series. In another example, the first laser scanner and the second laser scanner are in parallel.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a flowchart for the monohydrate processing of raw trona ore, according to an embodiment.

FIG. 2 is a flowchart for processing and sorting of trona ore, according to an embodiment.

FIG. 3 is a side view of an ore-sorting system, according to an embodiment.

FIG. 4 is a block flow diagram for processing trona ore including having two sorters working in parallel for feeding different rock size ratios, according to an embodiment.

FIG. 5 is a block flow diagram for sorting trona ore, according to an embodiment.

### DETAILED DESCRIPTION

Embodiments disclosed herein are related to assemblies, systems, and methods of processing trona and ore sorting using sensor-based sorting systems in order to create a range of market saleable refined trona products. The assemblies, systems, and methods of ore sorting include a method for separating an ultra high-grade of trona ore to create a range of market saleable products and a high-grade ore to be sent to a mill for further processing. In some examples, the trona ore can be physically separated as low grade and ultra high-grade before the ore is processed to upgrade the ore to create a range of market saleable products. The method involves performing ore sorting via laser scanning on the raw unprocessed trona ore in its natural state obtained after a first round of sorting using X-ray transmission. The stream of material accepted by the XRT scan is then scanned via laser to concentrate a material stream of high-grade trona. The rejected particles from laser sorting are high purity trona ore that are sent to the mill for further processing, while the accepted particles are of ultra-high-grade trona collected and shipped in their raw form.

Soda ash can either be produced synthetically or naturally. In some examples, soda ash can be produced by either the less prevalent Leblanc method or the more prominent Solvay process. In the Leblanc method, sodium sulfate is produced by treating salt with sulfuric acid to produce a salt cake. The cake is then roasted with limestone and coal in a rotary furnace to obtain a sodium carbonate and calcium sulfide. This mixture, known as black ash, is then dissolved in water, concentrated, and crystallized to produce sodium carbonate. The Solvay process utilizes brine, limestone, and ammonia (as a catalyst) to produce sodium carbonate. The Solvay process consists of several complex steps consisting of brine purification, formation of sodium hydrogen carbonate, formation of sodium carbonate, and the recovery and recycling of ammonia. The product of the Solvay process is sodium carbonate.

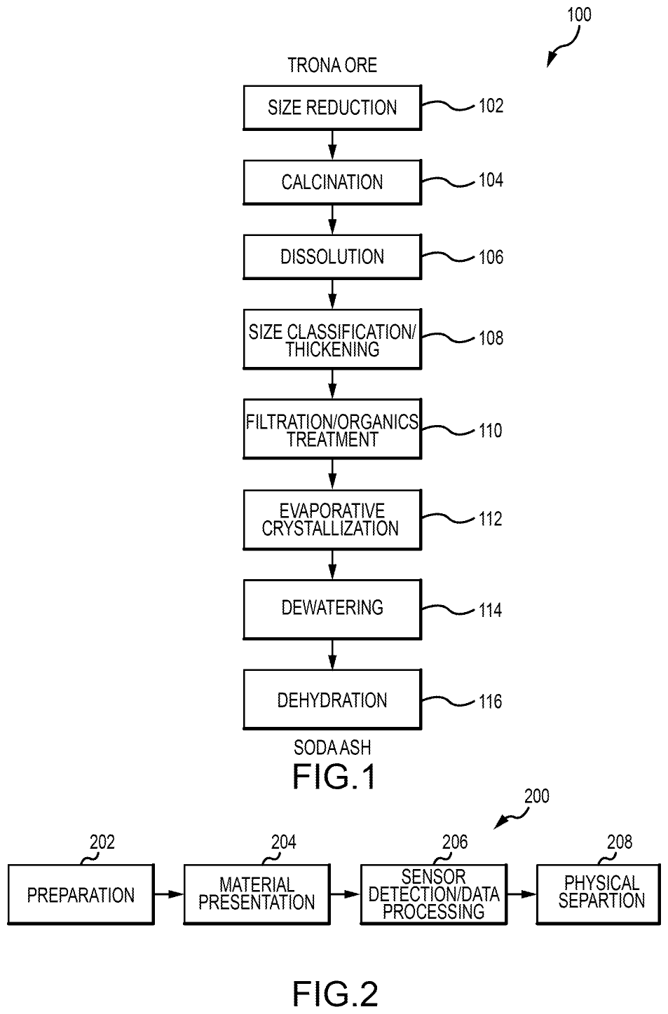

To convert natural trona ore to soda ash, a multi-step purification process is needed. The production of soda ash can either be achieved by the monohydrate or the sesquicarbonate process. The monohydrate method is the preferred method over the sesquicarbonate method due to the raw trona ore leaching more slowly than the calcined ore in the sesquicarbonate method, and because the leach solution requires more extensive purification. FIG. 1 is a flowchart for the monohydrate processing of raw trona ore to make soda ash. Trona and soda ash are naturally soluble in water, however, raw trona ore includes minerals that are insoluble. These insolubles are finely disseminated throughout the beds and are composed of clay minerals/organics, dolomite, calcite, quartz, feldspar, pyrite, and shortite. The insoluble material are separated from the trona ore to produce a trona ore feed suitable for further processing and for making soda ash.

The monohydrate process 100 can include a first act 102 of precision crushing and screening of the ore to reduce the size of the ore for further processing. The ore can then be calcinated in a kiln in act 104 to drive off unwanted gases. The heat from the kiln converts the ore to crude sodium carbonate. In some examples, calcining of the raw ore is done in rotary calciners at ca. 120° C. or higher. In some examples, a rotary calciner can include a large, rotating cylinder or drum, through which process gas is passed, allowing it to directly contact the material to cause the intended reaction. In some examples, the drum can be externally heated to avoid direct contact between the material and process gas, however, direct-fired units are also utilized. The trona ore of high purity can be sold without calcining while the lower purity ore can go to the mill.

In act 106, water can then be added to dissolve the crude sodium carbonate. Tailings generated from the calcining process in act 106 are discharged to the tailings tank. The tailings tank also receives fly ash and bottom ash generated from using coal to fire the calcining kiln and the steam boiler. In some examples, as shown in act 108, this waste material can be treated in a thickening tank by adding anionic and cationic flocculants to the tailings to increase the solids content from about 10% to about 50% solids. In some examples, the solution formed is then filtered to remove any impurities in act 110. Water contained within the solution can be evaporated in act 112 to form a soda ash crystal slurry. In act 114, a centrifuge is then used to separate the remaining water from the soda ash crystals. The soda ash will then be sent to rotary driers for dehydration in act 116, which produces the final product.

The first step of the process, act 102, can include the assemblies, systems, and methods of ore sorting described in greater detail below. Ore sorting includes crushing and screening the trona ore to separate ultra high-grade ore from high-grade ore to create a range of market saleable products.

FIG. 2 is a flowchart illustrating a process 200 for sorting of trona ore, according to an embodiment. Ore sorting can be employed at any stage of a mining project. However, the ore sorting is beneficial in a progressively decreasing mine grade to make ore that was once deemed uneconomical to now be mined economically. This can be done because the cut-off grade of the deposit can be substantially lowered. A cut-off grade is defined as the minimum grade required for a mineral or metal to be economically mined or processed. Material above the cut-off grade is considered ore, while the material below is considered waste. In some examples, ore sorting can be typically utilized to pre-concentrate the process plant feed. Other advantages of ore sorting include extending mine life and prolonging mining operations when the grade of the deposit progressively decreases; without having to increase mill size. In some examples, before a mine is in production, ore sorting can reduce the size of the processing plant required for a project. Energy consumption can also be substantially lowered per tonne of concentrate produced and ore sorting also can reduce the amount of grinding of waste material which lowers the wear on the circuit. Ore sorting can also be considered more environmentally friendly by reducing the volume of water and reagent necessary to process the ore.

In the process 200, which is a general overview of the system and processing method, can include the preparation of the ore in act 202. In some examples, the particles to be sorted are crushed and screened to an applicable and predetermined size. In some examples, the system can include an ore crusher that pulverizes a raw ore into an ore particle comprising a diameter between about ⅛ inch and about 4 inches. In some examples, these particles can be crushed to include diameters less than 12 inches. In other examples, the particles can include diameters less than 10 inches, less than 8 inches, less than 6 inches, less than 4 inches, or less than 2 inches. In some examples the particles crushed can include a particle size in ranges between about ⅛ inch and about 8 inches. Other ranges can include between about ⅛ inch and about 1 inch, between about 1 inch and about 3 inches, between about 3 inches and about 4 inches, between about 4 inches and about 6 inches, between about 6 inches and about 9 inches, between about 9 inches and about 12 inches, between about 3 inches and about 8 inches, or between about ½ inch and about 4 inches. Particle size has an impact on throughput and the number of particles which can be detected, evaluated, and ejected per unit time. Larger particle sizes can decrease throughput for the system, in some examples.

Process 200 can further include act 204, which includes material presentation. In some examples, the individual particles that have been crushed can be introduced onto a fast-moving conveyor belt. In some examples, the particles can be organized on the conveyor in a monolayer such that each side of the particle can be analyzed, and such that every particle can be scanned. For some sensors and detection modes, it may be necessary to isolate each particle from its neighbors. The particles must also follow a defined path between detection point and ejection point to ensure that there is no misplacement and that the identified particles can be accepted or rejected as determined by a sensor.

The sensing of the particles is included in act 206. In some examples, the conveyor belt can be configured to pass under an X-ray transmission (XRT) source, which transmits X-rays through the particles and material towards a detector to determine atomic density of each particle sample. In some examples, the sensor can be linked to a computer algorithm that can be configured to make a real-time decision to accept or reject an analyzed particle.

The acceptance or rejection of the particle can include an act 208. In act 208 the particles are physically separated based on the decision on whether to accept or reject the particles. In some examples, the rejected particles are ejected from a high-pressure air valve connected to a compressor. The accepted particles fall into an “accept” bin, where the accepted particles can be further processed. In some examples, in the event the particles are too closely spaced, or located too closely together while they approach the ejector on the conveyor, some of the ore can be erroneously ejected along with the rejected and/or waste particles. In some examples, the rejected waste particles from the sorting in act 208 can be sent to a secondary ore sorter or a “scavenger” sorter. The scavenger sorter can be configured to analyze any waste and/or rejected particles that are misclassified and/or erroneously rejected. As such, sorting a second time with the scavenger sorter can minimize the loss of trona at this stage.

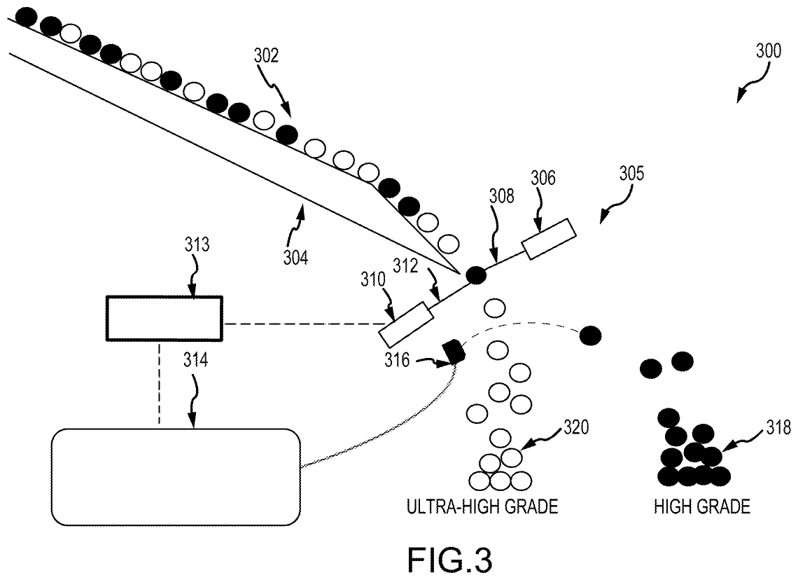

FIG. 3 is an isometric view of a trona ore processing system 300, according to an embodiment. In some examples, the processing system 300 includes a feed 302 that includes trona ore particles of various grades. In some examples, prior to the feed 302, the ore sorting system can include a trona ore screen system that includes an ore crusher and a filter as described in the process 200 above. The ore crusher can be configured to pulverize a raw ore into an ore particle comprising a diameter between about ⅛ inch and about 4 inches. In some examples, the processing system 300 can include a conveyor belt 304. The trona ore particles can be configured as a monolayer on the conveyer belt 304. In some examples, the conveyor belt can operate at a predetermined speed. The speed of the conveyor belt 304 can be configured to ensure the trona ore is disposed in a monolayer prior to the sensor. In some examples, the conveyor belt can have a variable speed. The speed of the conveyor belt 304 can be manually controlled or automatically controlled. In some examples, the trona ore particles can be arranged in a monolayer by the speed of the conveyor belt 304 and the method of loading the trona ore onto the conveyor belt 304. For example, the trona ore can be loaded on the conveyor belt 304 via a hopper configured to vibrate to better distribute the trona ore particles. In some examples, the conveyor belt 304 can include fins or other suitable partitions configured to arrange the trona ore particles in a monolayer and also prevent the trona ore particles from falling off the conveyor belt 304. In some examples, such as for some sensors and detection modes, it may be necessary to isolate each particle from its neighbors. In some examples, the trona ore particles also follow a defined path between detection point and ejection point to ensure that there is no misplacement and that the right type of particles (e.g., those having a predetermined trona concentration) are being accepted and/or rejected.

In some examples, the processing system 300 can include a beneficiation system that receives the ore particles having a predetermined size, the beneficiation system configured to increase an economic value of the trona ore by removing gangue material, resulting in a high-grade ore product. The beneficiation system includes a sorting system 305 that includes a sensor. In some examples, the sensor identifies trona ore having a predetermined trona concentration. For example, the sensor can be configured to identify trona ore that includes a trona concentration greater than 80%, greater than 90%, greater than 95%, or greater than 98.5%.

In some examples, the sorting system 305 can include any suitable dry separation procedure. For example, the sorting system 305 can include at least one of density, magnetic, electrostatic, optical, X-ray, or infrared separation. In at least one example, the sorting system 305 can include an X-ray transmission-based imaging processor to identify ore purity and a laser scanner. In other words, the XRT scanner can separates the high grade and gangue material, then it goes to the laser scanner to upgrade the ore.

In some examples, the sorting system 305 can include an X-ray transmission (XRT) source 306 and/or the X-ray transmission-based imaging processor configured to analyze the trona ore particles for their X-ray signal attenuations and determine atomic density of the trona ore particles. In some examples, the XRT source 306 can capture the transmitted X-rays and the data can be sent to a computer that is configured to use a pre-determined algorithm to decide whether to keep the particles or reject them as waste. The XRT source 306 can conduct the analysis instantaneously. The conveyor belt 304 passes under a XRT source 306 which transmits an X-ray 308 through the materials (i.e., the trona ore particles) towards a detector to determine an atomic density of each particle. The XRT source 306 is linked to a computer algorithm that makes a real-time yes/no decision to accept or reject the trona ore particle.

In some examples, the sorting system 305 further includes a laser scanner 310. In some examples, the laser scanner 310 transmits beams of various colors 312 onto the surface of the trona ore particle surfaces to determine reflectance, absorption and fluorescence. In some examples, the laser scanner transmits beams of coherent light that analyzes the trona ore particles for absorption, reflectance and fluorescence characteristics. The laser scanner's 310 data can then be sent to a computer where it will use various pre-determined computer algorithms to decide whether to keep the particles or reject them. In some examples, the laser scanner 310 can include a first laser 310a and a second laser 310b. In some examples, the first laser 310a includes a first color and a second layer 310b includes a second color different than the first color.

In some examples, the laser sorter can produce an ultra high-grade product with less than 2% and maximum 1.2% insolubles. No material is lost in the creation of the ultra high-grade product since the remaining material is also trona that will be fed to the mill. In some examples, the X-ray transmission-based imaging processor 306 and the laser scanner 310 are in parallel. In other examples, the X-ray transmission-based imaging processor 306 and the laser scanner 310 are in series.

In some examples, the processing system 300 further includes an ore separator 314. In some examples, the separator 314 can include an identification system configured to accept or reject ore. The separator 314 includes a high-pressure air jet diverter configured to eject the high-grade ore 318. In some examples, the separator 314 is an ore separator configured to accept or reject ore. A first-grade ore can be processed to create a range of market saleable refined trona products and a second-grade ore is sent to a mill. In some examples, the trona ore can include trona interbedded with at least one of a marlstone, limestone, oil shale, sandstone, or mudstone. The first-grade and/or accepted trona ore particles can include a trona concentration greater than a predetermined threshold (e.g., 95%). The second-grade ore has a concentration of marlstone, limestone, oil shale, sandstone, or mudstone that is too high. In other words, the concentration of trona ore in the rejected ore is too low (e.g., less than 95%). The high-grade ore 318 can be further processed as the mill grade material.

In some examples, the separator 314 can include a first trona ore feed having a large ore particle diameter and a second ore feed having a small ore particle diameter. The diameter of the ore feed can be determined and/or produced in a crushing and screening system of the ore sorting system. In some examples, the first ore feed can be fed to a first sorting system and the second ore feed can be fed to a second sorting system. The first sorting system and the second sorting system can both include every one and/or or some of the components of the sorting system 305 discussed above. In some examples, the first trona ore feed and second trona ore feed are in series. For example, the ore sorting system can further include a secondary ore sorter. The secondary ore sorter can be configured to analyze trona ore particles of a different size (e.g., larger or smaller) to identify and further separate trona ore particles prior to the sorting system that analyzes the trona ore with at least one of an X-ray transmission-based imaging processor or a laser scanner. In other examples, the first trona ore feed and second trona ore feed are in parallel.

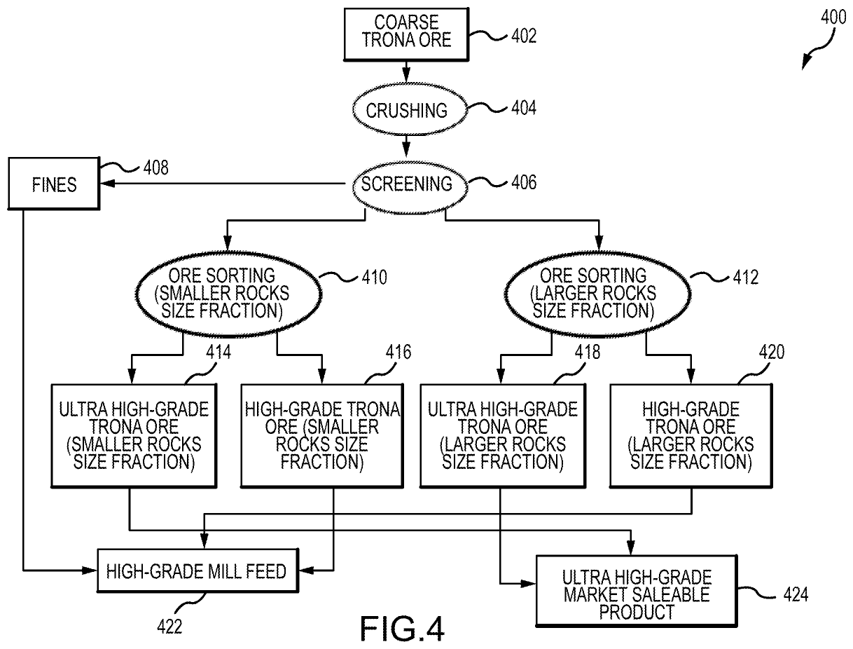

FIG. 4 is a flow diagram of a method 400 for the processing of trona ore, according to some embodiments. The method 400 for the processing of trona ore may utilize use any of the trona ore sorting systems and/or assemblies disclosed herein. The method 400 may include act 402, which includes mining and/or harvesting coarse trona ore. The coarse trona ore can include trona interbedded with at least one of a marlstone, limestone, oil shale, sandstone, or mudstone. The coarse trona ore can be mined by any suitable method known in the art to produce a raw ore feed. Act 402 may be followed by act 404, which includes crushing the trona ore. In some examples, crushing the trona ore can include pulverizing a raw ore into an ore particle comprising a diameter between about ⅛ inch and about 4 inches. In some examples, these particles can be crushed to include diameters less than 12 inches. In other examples, the particles can include diameters less than 10 inches, less than 8 inches, less than 6 inches, less than 4 inches, or less than 2 inches. In some examples, the raw ore feed comprises trona ore particles having a diameter larger than about ¼ inch. In some examples the particles crushed can include a particle size in ranges between about ⅛ inch and about 8 inches. Other ranges can include between about ⅛ inch and about 1 inch, between about 1 inch and about 3 inches, between about 3 inches and about 4 inches, between about 4 inches and about 6 inches, between about 6 inches and about 9 inches, between about 9 inches and about 12 inches, between about 3 inches and about 8 inches, or between about ½ inch and about 4 inches. Particle size has an impact on throughput and the number of particles which can be detected, evaluated, and ejected per unit time. Larger particle sizes can decrease throughput for the system, in some examples.

Acts 402 and 404 of the method 400 are for illustrative purposes. For example, the acts of the method 400 may be performed in different orders, split into multiple acts, modified, supplemented, or combined. In an example, one or more of the acts of the method 400 may be omitted from the method 400. Any of the acts of the method 400 can include using any of the ore sorting assemblies or systems disclosed herein.

Act 406 includes screening trona ore to produce an ore feed comprising ore particles. The act 406 of screening may include utilizing any of the ore sorting assemblies or systems disclosed herein or other systems of screening and/or filtration known in the art. In some examples, act 406 may include screening to separate high-grade ore from waste rock so that only rocks containing high amount or trona. In other examples, the screening is for rock size, as shown in FIG. 4. In some examples, the trona ore is sorted in to fines 408, which can be sent directly to a mill feed for further processing, smaller rock size fractions, and larger rock size fraction.

Act 410 including ore sorting for smaller rock size fraction and act 412 including ore sorting for larger rock size fraction can be conducted in parallel. In other words, the ore feed can include a first ore feed including a large ore particle diameter and a second ore feed including a small ore particle diameter.

The ore sorting in acts 410 and 412 can include using a sorting system to determine the ore grade of the rock. For example, the sorting system can include at least one of density, magnetic, electrostatic, optical, X-ray, or infrared separation. In some examples, act 410 and 412 can include identifying an impurity content of the ore particles by a sorting system. In some examples, the sorting system of the particle comprises utilizing X-ray transmission-based imaging to identify ore purity. In some examples, the first ore feed can be fed to a first sorting system and the second ore feed can be fed to a second sorting system. In some examples, the second sorting system can include a laser sensor. The laser sensor can transmit beams of various colors onto the surfaces of the trona ore particles to determine reflectance, absorption and fluorescence. In some examples, the first sensor system and the second sensor system are in series. In other examples, the first sensor system and the second sensor system are in parallel. In some examples, the acts 410 and 412 can include identifying an impurity content of the ore particles only by a laser scanner.

In some examples, the method 400 can further include Act 414 and Act 416. In acts 414 and 416, the trona ore is analyzed by purity and separated by grade of the trona ore. In some examples, the purity threshold can include about 95% trona. In other examples, the purity threshold can include about 98% trona. Acts 414 and 416 can be conducted via a sorting system that can include at least one sensor. The sensor can include an X-ray transmission (XRT) source configured to analyze the trona ore particles for their X-ray signal attenuations and determine atomic density of the trona ore particles. In some examples, the sensor can capture the transmitted X-rays and the data can be sent to a computer that is configured to use a pre-determined algorithm to decide whether to keep the particles or reject them as waste. In some examples, the sensor can include a laser sensor configured to transmit beams of various colors onto the surfaces of the trona ore particles to determine reflectance, absorption and fluorescence. In an example, the laser sensor can include a laser source having a first laser and a second laser. In some examples, the first laser includes a first color and a second layer includes a second color different than the first color, wherein the first laser and the second laser are configured to analyze trona ore particles for absorption, fluorescence, and reflectance characteristics. The sensor system can separate the trona ore into an ultra-high-grade trona 414 and a high-grade trona 416.

The same analysis can be conducted for the larger rock size fraction in act 412. In some examples, the method 400 can further include Act 418 and Act 420. In acts 418 and 420, the trona ore is analyzed by purity and separated by grade of the trona ore. In some examples, the purity threshold can include about 95% trona. In other examples, the purity threshold can include about 98% trona. Acts 418 and 420 can be conducted via a sorting system that can include at least one sensor. The sensor can include an X-ray transmission (XRT) source configured to analyze the trona ore particles for their X-ray signal attenuations and determine atomic density of the trona ore particles. In some examples, the sensor can capture the transmitted X-rays and the data can be sent to a computer that is configured to use a pre-determined algorithm to decide whether to keep the particles or reject them as waste. In some examples, the sensor can include a laser sensor configured to transmit beams of various colors onto the surfaces of the trona ore particles to determine reflectance, absorption and fluorescence. In an example, the laser sensor can include a laser source having a first laser and a second laser. In some examples, the first laser includes a first color and a second layer includes a second color different than the first color, wherein the first laser and the second laser are configured to analyze trona ore particles for absorption, reflectance and fluorescence characteristics. The sensor system can separate the trona ore into an ultra-high-grade trona 418 and a high-grade trona 420.

The sensor can conduct the analysis instantaneously. The second-grade 420 can be sent to be processed in act 422 as high-grade mill feed in some examples. In other examples, the second-grade can be further analyzed for either a different grade of trona ore and/or reevaluate to ensure proper ore sorting was conducted in acts 410 and 412. The ultra-high-grade trona in act 418 and act 414 from the ore sorting can be to create a range of market saleable refined trona products in act 424 for to convert the trona to soda ash. In some examples, separating the refined trona products quality ore from the mill feed quality ore can include using air jet diverters.

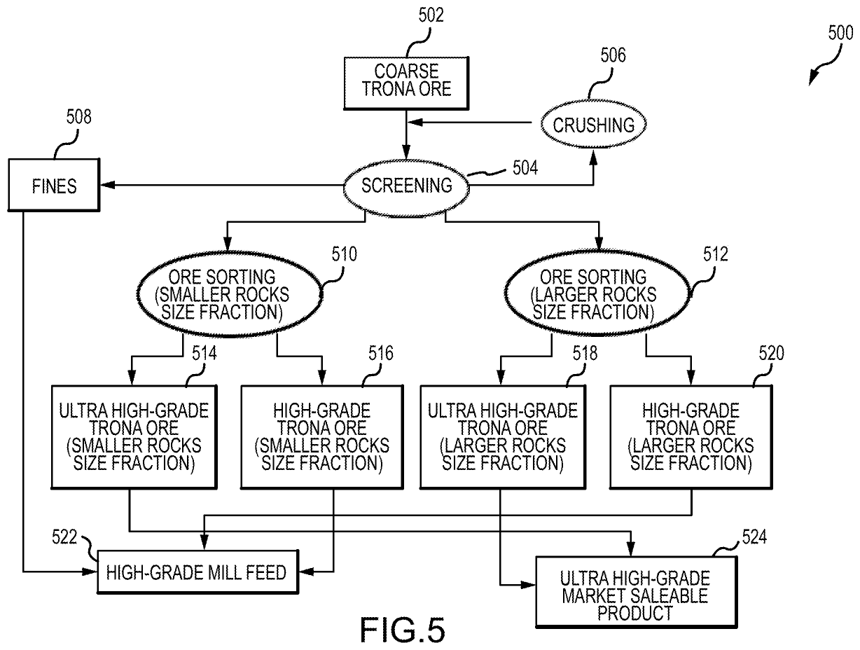

Similar to the method 400, FIG. 5 is a flow diagram of a method 500 for the purification of trona, according to some embodiments. The method 500 for the purification of trona may utilize use any of the ore sorting systems and/or assemblies disclosed herein. The method 500 may include act 502, which includes mining and/or harvesting coarse trona ore. The coarse trona ore can be mined by any suitable method known in the art to produce a crushable trona ore. Act 502 may be followed by act 504, which includes crushing the trona ore. However, as shown, act 504 of crushing may not be required, or after act 506 of screening, more crushing can be conducted to further improve the ore sorting processes described in act 510 and act 512.

In some examples, crushing the trona ore can include pulverizing a raw ore into an ore particle comprising a diameter between about ⅛ inch and about 4 inches. In some examples, these particles can be crushed to include diameters less than 12 inches. In other examples, the particles can include diameters less than 10 inches, less than 8 inches, less than 6 inches, less than 4 inches, or less than 2 inches. In some examples the particles crushed can include a particle size in ranges between about ⅛ inch and about 8 inches. Other ranges can include between about ⅛ inch and about 1 inch, between about 1 inch and about 3 inches, between about 3 inches and about 4 inches, between about 4 inches and about 6 inches, between about 6 inches and about 9 inches, between about 9 inches and about 12 inches, between about 3 inches and about 8 inches, or between about ½ inch and about 4 inches.

Acts 502 and 504 of the method 500 are for illustrative purposes. For example, the acts of the method 500 may be performed in different orders, split into multiple acts, modified, supplemented, or combined. Act 506 includes screening trona ore to produce an ore feed comprising ore particles. The act 506 of screening may include utilizing any of the ore sorting assemblies or systems disclosed herein or other systems of screening and/or filtration known in the art. In some examples, act 506 may include screening to separate rock size. In some examples, the trona ore is sorted in to fines as determined in act 508, which can be sent directly to a high-grade mill feed for further processing, smaller rock size fractions in act 510, and larger rock size fraction in act 512.

Act 510 including ore sorting for smaller rock size fraction and act 512 including ore sorting for larger rock size fraction can be conducted in parallel. In other words, the ore feed can include a first ore feed including a large ore particle diameter and a second ore feed including a small ore particle diameter. In some examples, the sorting of larger rock size fraction and smaller rock size fraction can be done in series, as required for feed into the sorting system for ore purity. After ore sorting for rock size in acts 510 and 512, the ore sorting in acts 514 and 516 can include using a sorting system to determine the ore grade of the rock.

For example, the sorting system can include at least one of density, magnetic, electrostatic, optical, X-ray, or infrared separation. In some examples, act 514 and 516 can include identifying an impurity content of the ore particles by a sorting system. In some examples, the sorting system of the particle comprises utilizing X-ray transmission-based imaging to identify ore purity. In some examples, the first ore feed can be fed to a first sorting system and the second ore feed can be fed to a second sorting system. In some examples, the second sorting system can include a laser sensor. The laser sensor can transmit beams of various colors onto the surfaces of the trona ore particles to determine reflectance, absorption and fluorescence. In some examples, the first sensor system and the second sensor system are in series. In other examples, the first sensor system and the second sensor system are in parallel.

In acts 514 and 516, the trona ore is analyzed by purity and separated by grade of the trona ore. In some examples, the purity threshold can include about 95% trona. In other examples, the purity threshold can include about 98% trona. Acts 514 and 516 can be conducted via a sorting system that can include at least one sensor. The sensor can include an X-ray transmission (XRT) source configured to analyze the trona ore particles for their X-ray signal attenuations and determine atomic density of the trona ore particles. In some examples, the sensor can capture the transmitted X-rays and the data can be sent to a computer that is configured to use a pre-determined algorithm to decide whether to keep the particles or reject them as waste. In some examples, the sensor can include a laser sensor configured to transmit beams of various colors onto the surfaces of the trona ore particles to determine reflectance, absorption and fluorescence. In an example, the laser sensor can include a laser source having a first laser and a second laser. In some examples, the first laser includes a first color and a second laser includes a second color different than the first color, wherein the first laser and the second laser are configured to analyze trona ore particles for absorption, fluorescence, and reflectance characteristics. The sensor system can separate the trona ore into an ultra-high-grade trona 514 and a high-grade trona 516.

The same analysis can be conducted for the larger rock size fraction in act 512. In some examples, the method 500 can further include Act 518 and Act 520. In acts 518 and 520, the trona ore is analyzed by purity and separated by grade of the trona ore. In some examples, the purity threshold can include about 95% trona. In other examples, the purity threshold can include about 98% trona. Acts 518 and 520 can be conducted via a sorting system that can include at least one sensor. The sensor can include an X-ray transmission (XRT) source configured to analyze the trona ore particles for their X-ray signal attenuations and determine atomic density of the trona ore particles. In some examples, the sensor can capture the transmitted X-rays and the data can be sent to a computer that is configured to use a pre-determined algorithm to decide whether to keep the particles or reject them as waste. In some examples, the sensor can include a laser sensor configured to transmit beams of various colors onto the surfaces of the trona ore particles to determine reflectance, absorption and fluorescence. In an example, the laser sensor can include a laser source having a first laser and a second laser. In some examples, the first laser includes a first color and a second layer includes a second color different than the first color, wherein the first laser and the second laser are configured to analyze trona ore particles for absorption, reflectance and fluorescence characteristics. The sensor system can separate the trona ore into an ultra-high-grade trona 518 and a high-grade trona 520.

The sensor can conduct the analysis instantaneously. The second-grade 520 can be sent processed in act 522 as high-grade mill feed in some examples. In other examples, the second-grade can be further analyzed for either a different grade of trona ore and/or reevaluate to ensure proper ore sorting was conducted in acts 510 and 512. The ultra-high-grade trona in act 518 and act 514 from the ore sorting can be processed to create a range of market saleable refined trona products in act 524 for to convert the trona to soda ash. In some examples, separating the refined trona products quality ore from the mill feed quality ore can include using air jet diverters.

In some examples, the ore is placed in a calciner to convert the trona to soda ash. The process is based on thermal treatment which causes its decomposition and the elimination of gangue materials. Trona calcining is a key step in the production of soda ash from trona ore. It is achieved by heating the trona to an appropriate temperature to drive off carbon dioxide and water. The process proceeds in a sequence of steps. The decomposition reactions occur as follows:

2(Na₂CO₃*NaHCO₃*2H₂O)=>3Na₂CO₃+5H₂O+2CO₂

The conversion of trona into soda can be conducted at any temperature over 70° C., however, the rate of the reaction does not become significant enough to until a temperature of approximately 120° C. is reached. At temperatures greater than 800° C., the ore will fuse and become unusable. Calcining is conducted in rotary furnaces at temperatures which exceed 120° C. At temperatures below 120° C., wegscheiderite (Na₂CO₃*3NaHCO₃) and sodium carbonate monohydrate (Na₂CO₃*H₂O) form as intermediaries.

Trona needs to go through a multi-step beneficiation process to be converted to soda ash. The beneficiation process includes a beneficiation system that receives the ore particles having a predetermined size, the beneficiation system configured to increase an economic value of the trona ore by removing gangue material, resulting in a high-grade ore product. The monohydrate process is the most popular. In this process, the calcined material is combined with water to dissolve the soda ash and to allow separating and discarding of the insoluble material such as shale or shortite by settling and/or filtration. The clear liquid that is produced by this process is concentrated in evaporators and the dissolved soda ash precipitates as crystals of sodium carbonate monohydrate (Na₂CO₃*H₂O). The other dissolved impurities that occur with the trona remain in solution. The crystals and mother liquor are then separated by centrifuge. The crystals of sodium carbonate monohydrate are then calcined a second time to liberate water that was trapped during crystallization. The finished product is then cooled, screened, and shipped.

### Example 1

In Example 1, trona ore samples were collected from the mining operation in Green River, Wyoming to assess the feasibility of achieving a market saleable ultra-high-grade ore product using laser-based particle ore sorting. The samples were split into two size fractions: 8 to 20 mm (smaller size fraction) and 20 to 40 mm (larger size fraction). Waste content in ore in Example 1 is presented as % insolubles. Trona purity is reported where necessary.

Full scale PRO Laser sorters were used to conduct the test presented in Example 1. Ore sorting using laser-based technology was successful in creating an ultra-high-grade ore, as the grade of the product trona was 98.8% (1.2% insolubles).

A sample of 203.5 kg of the trona ore was fed into the PRO Laser sorter containing 3.0% insoluble. 83.3% of the original feed mass was identified as mill feed ore and 16.7% was identified as market saleable ultra-high-grade ore product. The final product of ultra-high-grade ore had an amount of 1.9% insoluble (98.1% trona purity) and a high-grade mill feed product containing 8.0% insolubles (92% trona purity).

Table 1 below summarizes the results from the trona ore sorting tests using laser sorting technology.

TABLE 1

| Size | | Mass Pull to | Ultra-High- | High-Grade |
|---|---|---|---|---|
| Fraction | Feed Grade | Product | Grade Ore | Mill Feed |
| [mm] | [% Insolubles] | [%] | [% Insolubles] | [% Insolubles] |
| 20-40 | 3.0 | 16.7 | 1.2 | 3.4 |

### Example 2

In Example 2, trona ore samples were collected from the mining operation in Green River, Wyoming to assess the feasibility of achieving an ultra-high-grade ore product using laser-based particle ore sorting. The samples were split into two size fractions: 8 to 20 mm (smaller size fraction) and 20 to 40 mm (larger size fraction). Waste content in ore in Example 2 is presented as % insolubles. Trona purity is reported where necessary.

Full scale PRO Laser sorters were used to conduct the test presented in Example 2. Ore sorting using laser-based technology was successful in creating an ultra-high-grade ore, as the grade of the product trona was 98.3% (1.7% insolubles) and 98.1% (1.9% insolubles) for the smaller size fraction and the larger size fraction, respectively.

A sample of 127.5 kg of the smaller size was fed into the PRO Laser sorter while containing 3.4% insolubles. 43.9% of the original feed mass was identified as mill feed ore and 56.1% was identified as market saleable ultra-high-grade ore product. The final product of ultra-high-grade ore had an amount of 1.7% insoluble (98.3% trona purity) and a high-grade mill feed product containing 5.6% insoluble (94.4% trona purity).

A sample of 356.5 kg of the larger size fraction was fed into the PRO Laser sorter containing 3.9% insoluble. 32% of the original feed mass was identified as mill feed ore and 68% was identified as market saleable ultra-high-grade ore product. The final product of ultra-high-grade ore had an amount of 1.9% insoluble (98.1% trona purity) and a high-grade mill feed product containing 8.0% insolubles (92% trona purity).

Table 2 below summarizes the results from the trona ore sorting tests using laser sorting technology.

TABLE 2

| Size | | Mass Pull to | Ultra-High- | High-Grade |
|---|---|---|---|---|
| Fraction | Feed Grade | Product | Grade Ore | Mill Feed |
| [mm] | [% Insoluble] | [%] | [% Insoluble] | [% Insoluble] |
| 8-20 | 3.4 | 56.1 | 1.7 | 5.6 |
| 20-40 | 3.0 | 68 | 1.9 | 8.0 |

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean±10%, ±5%, or +2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

We claim:

1. An ore-sorting system, comprising:
a trona ore screen system comprising an ore crusher and a filter, the screen system configured to produce an ore feed comprising ore particles having a predetermined size;
a beneficiation system that receives the ore particles having a predetermined size, the beneficiation system configured to increase an economic value of the trona ore by removing gangue material, resulting in a high-grade ore product, the beneficiation system comprising a laser scanner; and
a sorter configured to separate the high-grade ore product from the gangue material, the sorter comprising an identification system configured to accept or reject ore, wherein accepted ore is deposited in a bin and rejected ore is ejected with a high-pressure air jet.

2. The ore sorting system of claim 1, wherein the trona ore comprises trona interbedded with at least one of a marlstone, limestone, oil shale, sandstone, or mudstone.

3. The ore sorting system of claim 1, wherein the ore crusher pulverizes a raw ore into an ore particle comprising a diameter between about ⅛ inch and about 4 inches.

4. The ore sorting system of claim 1, wherein the laser scanner identifies trona ore having a trona concentration greater than 95%.

5. The ore sorting system of claim 1, wherein the laser scanner identifies trona ore having a trona concentration greater than 98%.

6. The ore sorting system of claim 1, wherein the laser scanner identifies trona ore having a trona concentration greater than 98.5%.

7. The ore sorting system of claim 1, wherein the beneficiation system further comprises a dry separation including at least one of density, magnetic, electrostatic, optical, X-ray, or infrared separation.

8. The ore sorting system of claim 1, wherein trona ore screen system comprises a first trona ore feed including a large ore particle diameter and a second ore feed including a small ore particle diameter, wherein the first ore feed is fed to a first beneficiation system and the second ore feed is fed to a second beneficiation system.

9. The ore sorting system of claim 8, wherein the first trona ore feed and second trona ore feed are in series.

10. The ore sorting system of claim 8, wherein the first trona ore feed and second trona ore feed are in parallel.

11. An ore-sorting system, comprising:
an ore feed intake configured to receive trona ore particles;
a conveyer belt that receives the trona ore particles from the ore feed intake and carries the trona ore particles to be evaluated, wherein the trona ore particles are configured as a monolayer on the conveyer belt;
a laser sensor configured to examine the trona ore particles on the conveyor belt to evaluate the concentration of trona in the trona ore particles and identify a high-grade ore product, the sensor comprising a laser scanner; and
an ore separator that divides the high-grade ore product from a waste material based on the results of the sensor.

12. The ore sorting system of claim 9, wherein the laser scanner transmits beams of coherent light that analyzes the trona ore particles for absorption, fluorescence, and reflectance characteristics.

13. The ore sorting system of claim 11, wherein the ore separator comprises an identification system configured to accept or reject each trona ore particle, wherein an accepted trona ore particle is deposited in a bin and a rejected trona ore particle is ejected with a high-pressure air jet.

14. The ore sorting system of claim 13, wherein the sensor further comprises an XRT source configured to analyze the trona ore particles for their X-ray signal attenuations and determine atomic density of the trona ore particles.

15. A method for purification of trona, the method comprising:
screening trona ore from an ore deposit to produce a trona ore feed comprising trona ore particles having a predetermined size;
placing the trona ore feed on a conveyer belt that receives the ore particles having a predetermined size;
identifying an impurity content of the ore particles by a dual laser scanner; and
separating the ore particles using air-jet diverters based on a purity threshold to increase an economic value of the trona ore by removing high-grade mill feed, resulting in an ultra high-grade ore product, wherein an accepted ore particle is deposited in a bin and a rejected ore is ejected with a high-pressure air jet.

16. The method of claim 15, wherein the laser scanner transmits coherent light beams of various colors to analyze the trona ore particles for absorption, reflectance and fluorescence characteristics.

17. The method of claim 15, wherein the trona ore particles include a diameter between about ⅛ inch and about 4 inches.

18. The method of claim 15, wherein the purity threshold comprises about 95% trona.

19. The method of claim 15, wherein the purity threshold comprises about 98% trona.

20. The method of claim 15, wherein the purity threshold comprises about 98.5% trona.

21. The method of claim 15, further comprising crushing the trona ore prior to screening trona ore.

22. The method of claim 15, wherein the ore feed comprises a first ore feed including a large ore particle diameter and a second ore feed including a small ore particle diameter, wherein the first ore feed is fed to a laser scanner and the second ore feed is fed to a second laser scanner.

23. The method of claim 22, wherein the first laser scanner system and the second laser scanner are in series.

24. The method of claim 22, wherein the first laser scanner and the second laser scanner are in parallel.
